(19) United States
(12) Patent Application Publication
(10) Pub. No.: US 2010/0199563 A1
(43) Pub. Date: Aug. 12, 2010

(54) MECHANISM FOR THE ALIGNED CLOSURE OF SLIDING DOORS, IN PARTICULAR FOR UNITS OF FURNITURE OR COMPARTMENTS WITH TWO OR MORE DOORS

(76) Inventor: Guido BORTOLUZZI, Belluno (IT)

Correspondence Address: KEVIN J. MCNEELY, ESQ., 5335 WISCONSON AVENUE, NW, SUITE 440, WASHINGTON, DC, 20015, US

(21) Appl. No.: 12/665,726

(22) PCT Filed: Jun. 30, 2008
(86) PCT No.: PCT/EP08/05341

§ 371 Date: Dec. 20, 2009

(30) Foreign Application Priority Data
Jun. 29, 2007 (IT) BL2007A17

(51) Int. Cl. E05D 15/16; E05D 13/00

(52) U.S. Cl. 49/128

(57) ABSTRACT

The invention regards to a mechanism for the aligned closure of sliding doors (1-3), in particular for furniture or compartments (V1-V3) with two or more doors, with a sliding door (1, 2 or 3) for each compartment, and where each compartment opens by sliding and overlapping of one door with one of the adjacent doors and closes in alignment with the adjacent doors. The mechanism consists of a single bracket (10) for each door, one end of the bracket (10) being fixed on the door, and its opposite end being equipped with a first sensing bearing (13) to run along a cam guide (70), said bracket (10) being suitable for inclination and transversal movement with a carriage (30), which also allows it to slide along a rail (50) to be positioned on the upper surface of the compartments. The carriage (30) can be adjusted transversally and the bracket (10) can move axially in relation to the carriage (30). An arm (14), one end of which is firmly attached to the bracket (10), while the other end (14a) is equipped with at least a second sensing device having a bearing (15, 15′), can run along an other longitudinal cam guide (60) using the same bracket (10) for inclination and movement.

### TECHNICAL FIELD

The invention regards to a mechanism for the aligned closure of sliding doors in particular for units of furniture or compartments with two or more doors. Such mechanism comprises a support and guide mechanism for the sliding doors, in particular for units of furniture or compartments with two or more doors with aligned closure, where each compartment opens by the sliding and overlapping of one door with an adjacent door.

### BACKGROUND ART

According to a known method, two or more unit panels or doors for example, may be converted into sliding doors on one or more vertical planes in a parallel position one to the other, having been attached to upper and lower brackets that slide along respective and separate tracks on the upper and/or lower panels of the unit.

The unaesthetic appearance of units fitted with these types of sliding doors, which when closed are positioned on different, albeit parallel planes with little distance one from the other, has led the sector to develop sliding door solutions that let remain the doors aligned when closed while thereby ensuring that said doors overlap when open.

In this respect, a known technical solution is provided by IT 1.208.152 proposed in 1986, according to which, the task of aligning the door panels positioned in a closed position with a drive mechanism consisting of a double longitudinal and orthogonal guide connected to a relative sliding mechanisms, the orthogonal guide having been attached by extreme curved parts capable of adjusting the direction of the sliding mechanisms upon manually pushing the unit door that forces the unit door to immediately change track prior before the final closure of the door or in contrast, during the initial opening of the door.

This solution, which has also resolved the issue of aligning the sliding doors in a closed position, has caused a certain complexity of construction and assembly, in addition to a certain bulkiness of the operational member.

Another solution is proposed by IT 1.247.456, according to which aligned closure of doors can be achieved through the use of guides with inwardly curved ends, sliding elements that can be brought to a diagonal or inclined position, their ends coming into contact with the curved ends of the guides, with subsequent inclination of the sliding doors during when these overlap upon opening or closure return.

This solution also in some way resolves the issue of aligning the closed doors, but has often shown itself to be imprecise and unreliable due to the frequent exit of the sliding devices from their guides during inclination of the sliding device following each non-standard manual pushing of a door.

These and other issues are resolved by the method proposed by IT 1.337.830 according to which a wide bracket is positioned to one side of each door to be converted into a sliding door, which is aligned upon closure, said bracket being supported by the individual doors that transversally slide on guides fitted to two carriages, positioned along the lateral extremities of the bracket and equipped with a pulley and an idler wheel to run along the track and along a stabilisation guide that runs parallel to said track, being one of the two carriages equipped with a sensing device/feeler that slides along a cam guide near the track and the other carriage equipped with a sensing device that slides along a second guide, farther away from said track, in such a way as to result in inclination of the bracket and thus of the door attached to it when the sensing devices of the two carriages reach the final, curved section of the respective cam guides.

Only one practical inconvenience has essentially been identified in the use of this method. Said inconvenience results from the difficulty in using a single track in the event of a unit of furniture having more than two sliding doors since the size of the brackets and carriages of the first two doors prevent the third bracket from passing along the same track when the third door is open and the third door therefore remains only partially open and does not allow easy access to the respective compartment.

Another insignificant restriction found in the development of IT 1.337.830 results from the fact that, since the sliding and movement supports are aligned and positioned on one side of the sliding door, said device is cantilevered and makes difficulties when supporting and guiding doors having large surface and therefore of a certain weight, unless its bearing parts are strengthened.

### TECHNICAL PROBLEM

The objective of the invention is to create a mechanism for the aligned closure of sliding doors with two or more doors in particular for units of furniture or compartments. Especially the object regards to a sliding device for one or more doors or unit and compartment doors, the mechanism of which, in addition to being aligned in a closed position allows each door to be opened with overlapping of the sliding door and the closed door with one of the adjacent compartments while utilising the same guide rail thus providing maximum accessibility and practical use of each compartment.

Within the scope of this object, another important aim is to develop a sliding device for doors or unit or compartment doors, which is sufficiently strong and more balanced and is thus able to support even doors or unit doors with a large surface area and corresponding higher weight that have very light movement and are thus safe and practical.

Another important aim of this invention is the introduction of a constructive simplification, with improved performance of IT 1.337.830 which it is our aim to improve, requiring, for each unit door, the application of a single bracket, thus significantly reducing the length and size and eliminating the two current transversal sliding carriages of the door.

### TECHNICAL SOLUTION

The objects are solved by the mechanism having features according to claim 1. Preferred aspects and embodiments are subject-matter of dependent claims.

Especially, there is preferred a mechanism for the aligned closure of sliding doors, in particular for furniture or compartments with two or more doors, with a sliding door for each compartment, and where each compartment opens by sliding and overlapping of one of the doors with one of the adjacent doors and closes in alignment with at least one of the adjacent door, characterised in that it comprises
a single bracket or support plate for each of the doors, one end of the bracket being positioned on the upper side of said door, especially being positioned approximately on a centre line of the upper side of said door, the opposite end of the bracket being equipped with a first sensing wheel or bearing, to be positioned at or in and to run along a longitudinal cam guide, said bracket being suitable for inclination and transversal movement with a longitudinal sliding carriage, which also allows the bracket via the carriage to slide along a rail preferably to be positioned on the edge of the upper surface of the compartments to be closed or opened;
the longitudinal sliding carriage of the bracket and of its door, said carriage being equipped with one or more bearing elements or pulleys that are adjustably transversally and by one or more bearing elements or wheels that are rendered transversally adjustable and by its sliding movement along the rail, in addition to being equipped with pivot wheels or bearings on which the bracket can move axially in relation to the carriage and can therefore move transversally in relation to the longitudinal opening and closing movement of the doors to open or close the compartments; and
an arm, one end of which is firmly attached to the support bracket of each door, while the other end is equipped with at least a second sensing device having at least one wheel or bearing, to be positioned and to run along an other longitudinal cam guide using the same bracket for inclination and movement, with its door in motion, in relation also to the form of the cam guide to which the second sensing device is connected.

Especially, the one end of the bracket can be firmly attached to the centre line of the upper edge of a door, while the other end of the bracket is equipped with at least a first sensing device having the first sensing wheel or bearing, to be positioned and to run along the longitudinal cam guide that has curved structure of its ends formed as curvature, and while the bracket together with the first sensing device and with a second sensing device having such second sensing wheel or bearing, attached to a second cam guide having curved ends formed as curvatures, defines the inclination and the movement by which the door, during opening of the compartment, can overlap the adjoining door that is closed over its adjoining compartment.

Especially, a bracket of any other door has one end, which can be firmly attached at the centre line of the upper edge of the corresponding same other door, while the other end is equipped with at least a first sensing device having such first wheels or bearings, to be positioned and to run along the or such a cam guide that has curved structure of its ends formed as such curvatures, and that this bracket together with a second sensing device having such second wheels or bearings, attached to the or such a second cam guide and its curved ends formed as curvatures defines the inclination and the movement by which the same other door, during opening of the corresponding compartment, can overlap the adjoining door that is closed over its adjoining compartment.

It is preferred, that each bracket is rendered stable by one end of arm, while the other end is equipped with the second sensing device, preferably arranged with two wheels or bearings and with a stabilising bearing or wheel attached to an adjustable plate, said wheels or bearings sliding within a cam guide, which with it curvatures and together with the movement of the first sensing device are capable of setting the inclination required in the bracket for closing the respective door by overlapping of the adjoining door during the opening phase of its compartment as well as setting the closure alignment position.

Especially, each bracket has a lower surface that has a compartment or first cavity, on the one end and a compartment on the opposite end, said compartments being suitable for housing and guiding an upper section of two respective joint members or sections of the co-operating carriage, this carriage being guided within said compartments or cavities by the wheels or bearings and by its bearings or wheels, which slide along tracks of the same bracket.

The carriage can have one end with an attached pivot, especially pin or bar, which allows a plate to move on said pivot, thus also allowing movement of the idler bearing elements or pulleys that are adjustably transversally and being positioned on the plate.

The carriage can have a section, that contrasts section and is deeper, wider and/or higher enabling it to house lateral guides and a frontal guide, especially fronatl guide cavity, in addition to having a compartment to house a viscous-fluid soft-closing system to act on one of its racks that is housed in the same compartment and has a dampening action in respect of the traction action of elastic devices arranged to return the bracket into alignment on the carriage.

Especially, in a suitable axial position, a pin or bar is solidly attached to the higher section of the carriage, said pin or bar being capable of moving a further plate to which the especially two bearing elements or wheels that are rendered transversally adjustable at the carriage are attached, these wheels being able to be positioned in a transversal balancing guide of the rail.

According to a preferred version the rail being a single rail, inclusive of a single track, on which are positioned a pair of the adjustable sliding bearings or pulleys of the carriage, and inclusive of a balancing guide, on which are positioned a pair of the adjustable sliding wheels of the carriage, said rail being attached to the upper surface of a top panel of the unit of furniture or at any element covering two or more compartments, and said rail being positioned alongside two guide members, of the cam guides for a pair of compartments, as well as to sections of said guide members with cam guides for each adjoining compartment.

Especially, such a guide member presents an undercut undercut groove that is parallel to and in proximity to the track, with at least one end curvature having an especially large curve ending with the compartment to be opened in proximity of an external side of the compartment or unit of furniture.

According to a preferred mechanism such a guide member with an upper groove running parallel to the track but is positioned to the rear of the guide, and having at least one end curvature with a narrower curvature radius than that of the other guide, being even inferior to the value corresponding to the length of the arm of the bracket attached to it.

Especially, the alignment of the first sensing device having the first wheels or bearings of the bracket in the cam guide of the guide member, allows the bracket and its door to move however much is necessary to reach the closed aligned position, with the sensing device positioned along the final curved section formed by a/the curvature of that cam guide in an open position, overlapping the adjoining door, with the sensing device having the first wheels or bearings positioned along a straight section of that cam guide.

Especially, the alignment of the second sensing device having the second wheels or bearings of the cam guide of a/the member allows the bracket to move and incline via its arm by however much is necessary, together with its door to reach a closed aligned position, with the sensing device having the second wheels or bearings positioned along its final curved section formed by a/the curvature of that cam guide to an open position, overlapping the adjoining door, with the sensing device having the second wheels or bearings positioned along a straight section of that cam guide.

Preferred is a mechanism in that the sliding, inclination and movement of each bracket and its door, in relation to the bracket and the adjoining door, is made possible and concurrent, by the presence of some/the adjustable plates on the carriage, through which the bearings or pulleys and wheels can remain aligned to the rail and or a/the track thereof and to the transversal balancing guide, while the carriage inclines with the bracket to which it is attached at the first compartment or cavity and the compartment formed in the bracket.

Especially, the opposite end of the arm being extended in a direction parallel to the rail and being distanced from the bracket in the direction parallel to the rail.

Especially, each of devices each comprising one of the brackets and its carriage are positioned such that one of the devices acts together with curvatures on a first end of one of the cam guides arranged above the first compartment, and that the other of the devices acts together with curvatures on the other, second end of the cam guides arranged above the second compartment.

Such mechanism is preferred, if the third one of the devices acts together with the curvatures on the other, second end of such cam guides above the third compartment, in which the curvatures arranged above the second compartment are curved in same direction like the curvatures arranged above the third compartment.

Especially, there is provided a sliding and support mechanism for each door or unit door having more than one compartment, said mechanism consisting of a single door, the bracket of which is equipped with a first sensing device which slots into a longitudinal cam guide and of a second sensing device which is fitted to one arm of said bracket and that slots into a second longitudinal cam guide in order that the bracket and its door may incline when it overlaps with the adjacent door, said bracket being attached to a transversal sliding carriage that is, in turn, equipped with an adjustable plate with wheels suitable for movement along the door track and a second adjustable plate with wheels which are slotted into a stabilisation guide running parallel to said track.

A preferred main characteristic of this mechanism is that it envisages the creation of a single support mechanism for each door or sliding door and for doors with aligned closure, said mechanism essentially consisting of:
a single track with parallel balancing guide positioned along the entire length of the unit's compartments, said track being connected to a rail or plate positioned on the upper surface of the top panel and in proximity to the opening edge of each compartment, which also includes stabilisation and cam guide members;
a pair of longitudinal cam guides for each pair of compartments to be closed and an additional pair of longitudinal cam guides for each additional adjoining compartment, said cam guides being fitted to the track and positioned on the upper panel of the unit, essentially parallel to the track itself, at least one extremity being suitably curved towards the base of the compartment and the extremity of the guide rail nearest the track having a greater length and curvature radius than the guide rail that is most external and furthest from said track;
a bracket or support plate for each door with sliding closure, one end of the bracket being positioned approximately on the centre line of the upper side of said door, its opposite end being equipped with a wheel or first sensing system to be positioned and guided by the groove or cam guides positioned farthest from the door track and the lower section of said bracket being equipped with suitable guides for transversal movement of the underlying support carriage positioned longitudinally along the rail;
one end being firmly attached to the bracket while the other end is equipped with an adjustable carriage or second sensing device, to be positioned and guided by the longitudinal channel or cam guide nearest to the door track; and
a longitudinal sliding carriage with an adjustable plate with a pair of pulleys at one end to run along the unit's track while a second adjustable plate is positioned on the centre line of said carriage and has wheels running along the balancing guide parallel to the track to ensure maximum stability of the door during movement, even in the event of inclination of the bracket during overlapping of the adjoining door.

As an alternative to standard hinged doors, some sliding door solutions may be advantageous if fitted to both cupboards and furniture in general and door frames or for the closure of compartments or spaces which have or require less space for opening or closure movements.

### DESCRIPTION OF DRAWINGS

For a better understanding of the proposed solution and an outline of the fulfillment of the specified objects, further details and illustrations are provided hereinafter, based on a form of assembly of the device in question, which is by no means exhaustive, and which is to be fitted to a three-door furniture unit, said description being supported by enclosed drawing, of which:

FIG. 1 is a transparent downward view, from the upper panel of a three-compartment cupboard, presented without doors, in which the upper panel has a single longitudinal track for the three respective doors and a series of cam guides for said doors, for fitting of the device in question onto each one of the doors of each compartment to allow the overlapping opening and aligned closure of each door;

FIG. 2 is a transparent downward view, from the same upper panel of a three-compartment cupboard shown in FIG. 1, in which it is shown with its respective doors in a closed position in alignment with the compartments, in which a similar number of devices are fitted to said doors;

FIG. 3 is a transversal, enlarged and partial view, as per section plan III-III of the upper panel in FIG. 1;

FIG. 4 is a transversal, enlarged view of a bracket, attached to the upper edge of the respective door to be supported and moved and is represented as per section plan IV-IV of FIG. 2;

FIG. 5 is a partial pan view of the same bracket shown in FIG. 4, from below;

FIG. 6 is an upward plan view of the support and longitudinal sliding carriage of the bracket in FIG. 4, to be positioned in the dedicated spaces of the lower surface of said bracket;

FIG. 7 is a vertical view, as per section plan VII-VII of the carriage shown in FIG. 6;

FIG. 8 is a downward view of the carriage shown in FIG. 7;

FIG. 9 is a transversal view of the carriage shown in FIG. 7, in the initial phase of application of the bracket shown in FIG. 4;

FIG. 10 is a transversal view of the carriage shown in FIG. 7, in the second phase of application of the bracket shown in FIG. 4;

FIG. 11 is a transversal view of the carriage shown in FIG. 7, generally applied to the bracket shown in FIG. 4, shown with its balancing arm and in the door's aligned closed position, as per section IV-IV of FIG. 2;

FIG. 12 is a plan view of the same bracket with carriage and arm as shown in FIG. 11, shown in the door's aligned closed position;

FIG. 13 is a vertical view of the end of the arm of the carriage shown in FIG. 12, from the direction indicated in XIII;

FIG. 14 is the same plan view as shown in FIG. 12 but with the door and bracket shown during inclination and movement resulting from overlapping of the adjacent door;

FIG. 15 is a transversal view of the same carriage and same bracket and door as shown in FIG. 11, when positioned on the track and on the cam guides pursuant to FIG. 3 and shown in the same aligned closure position, in which this view is completed by the identification of a non-restrictive solution for the guide on the lower section of said door;

FIG. 16 is the same view, as shown in FIG. 15, of the carriage and bracket with the door shown in the opening and moving position resulting from overlapping of the adjacent door;

FIG. 17 is a downward view of the three-door cupboard and is the same as the view shown in FIG. 2 but with an additional open lateral compartment and with the relative door overlapping the adjoining central door, which is in a closed position;

FIG. 18 is a downward view of the same cupboard as shown in FIG. 11, but with its lateral door opposite the previous door, which is shown in open position and overlapping the central door which is in a closed position.

### MODE FOR INVENTION

The same details are presented or are intended as having been presented in all figures with the same reference number.

As per the construction solution illustrated in the abovementioned figures, a device A, for the aligned closure of sliding doors 1, 2 and 3 proposed as a mechanism, essentially consists of a bracket 10, which is fitted to a sliding carriage 30 along the track 51 and along the balancing point or guide 52, constituting the rail 50 to which it is also attached by means of a pair of longitudinal cam guides 60 and 70 fitted to the external surface of an upper panel C. One end 11 of this bracket 10, which is suitable for connection to the central section of the upper side of a door 1 or cupboard door, and an opposite end 12, equipped with a first sensing device with either first wheels or bearings 13, is placed in horizontal position to the door 1 and its wheel or bearing 13 is to be slotted into the longitudinal cam guide 70.

An arm 14 is connected to the same bracket 10 and its opposite end 14a is equipped with a second sensing device with either wheels or bearings 15 fitted to a rotating plate 16 on a pivot 17 and to which at least one other guide wheel 18 is attached. This second sensing device preferably with its bearings 15-15′ is positioned in orthogonal fashion to the first sensing device having the first wheels or bearings 13, and are to be slotted into the longitudinal cam guides 60. The arm extends in a direction parallel to track 51.

The sliding carriage 30 being a longitudinal sliding carriage 30 consists of an essentially flat member 31 with an end 32 that is suitable for supporting a pivot 40 of an adjustable plate 41 onto which a pair of pulleys 42-43 is pivotable beard that will run along the track 51.

At the same end 32 of the carriage 30 there is mounted a transversal bar 45 at the ends of which are two pairs of bearings 46a-46b and 47a-47b.

A vertical pin 33 is positioned in a suitable axial position at the upper side of the sliding carriage 30. This vertical pin 33 is suitable for supporting a guide wheel 34.

The flat section 31 of the carriage 30 is connected to another flat section which is both higher and wider section 36 and which has a slot providing a compartment 37 for a rack 37a to be used in connection with a viscous fluid soft-closing system 37b, as well as a frontal guide cavity 38 and a pair of lateral guides 39, 39a-39b.

A vertical bar 46 is also solidly attached downwardly to this heightened section 36 and is suitable for supporting and horizontally rotating a plate 47 to which a pair of wheels 48-49 is fitted.

The presence of a pin or bar as the pivot 40 allows the plate 41 and the pair of pulleys 42-43 fitted to it, to be moved independently in respect of the longitudinal axis of the carriage 30 to which they are attached, and the presence of the pin or bar 46 also allows the plate 47 and its two wheels 48-49 to move independently in respect of the axis of the carriage 30.

As previously mentioned, the pulleys 42-43 are to be slotted into the track 51 of the guide rail 50, and the wheels 48-49 are to be slotted into the balancing guide 52 to work together with the pulleys 42-43 to support the bracket 10 and the door 1 attached to it.

The possibility of moving the plate 41 and its pulleys 42-43 and the possibility of moving the plate 47 and its wheels 48-49 ensures the possibility of constantly maintaining said pulleys 42-43 and said wheels 48-49 along respective longitudinal slots forming the track 51 and the balancing guide 52 of the guide rail 50, even when the bracket 10 and its door 1 are in an inclined position to overlap the adjoining door 2, as detailed below.

Along its lower surface and at the side of its end 11, said bracket 10 has a first slot or cavity 20 for housing the plate 31 of the carriage 30, while lateral surfaces of the bracket 10 each form a sliding track 21 and 22, respectively, for the two bearings 46a-46b and 47a-47b at the transversal bar 45 of the carriage 30, thus allowing the effective transversal sliding movement of the bracket 10 on said carriage 30.

The movement of the bracket 10 on the carriage 30 is ensured by a greater length and position of a second cavity 23 of the bracket 10, which houses the upper lateral guide wheel 34 of the carriage 30, thus permitting a sliding movement along a length corresponding to the movement required of the bracket 10 and its door 1 in order to overlap the adjoining door 2 when said door 1 is to be moved to open a respective compartment V1. The second cavity 23 reaches farther into the bracket 10 from its lower side than the first cavity 20. The cavities 20, 23 are confined by the sliding tracks 21, 22 extending perpendicular to the rail 50.

The tracks 21 and 22 of the bracket 10 are interrupted by the presence of two downwardly extending lateral supports 24-25 upon which the arm 14 is fitted, while the end 12 of this bracket 10 has a higher slot providing a higher compartment 26 to house the wider and higher section 36 of the carriage 30.

This bracket 10 is completed by the presence of two lateral bearings 27-28 and by one end bearing 29 that are contained in the slot provided by the higher compartment 26 and drive the carriage 30, as detailed below.

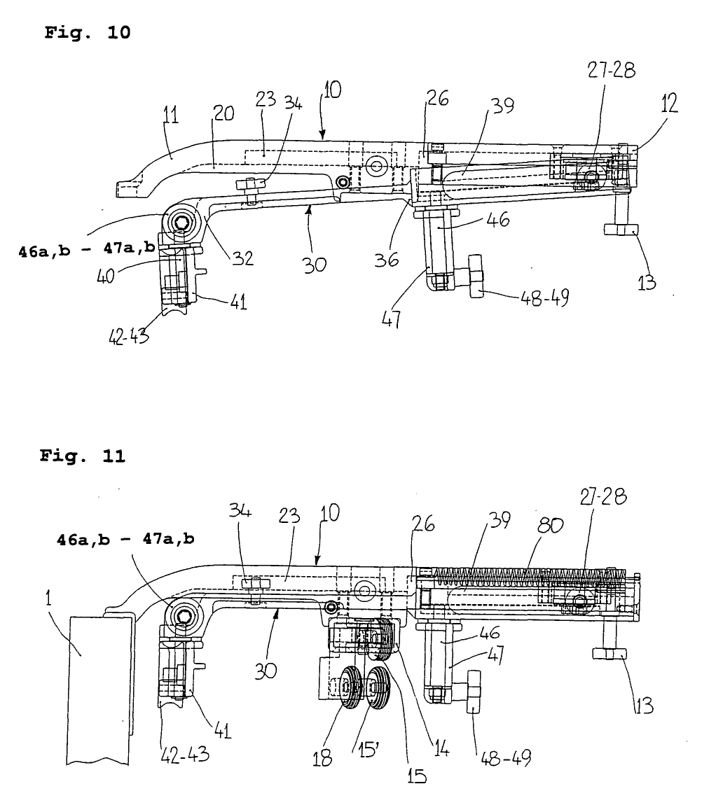

In relation to FIGS. 9, 10 and 11, it is shown how the bracket 10 can be fitted to the underlying carriage 30, essentially by slotting it into the first cavity 20 and higher compartment 26, respectively, so that it can then move along the carriage 30 to transversally move the respective door 1 while the carriage 30 slide longitudinally along the rail 50.

As can be seen in FIGS. 9, 10 and 11, the bracket 10-carriage 30 combination is achieved by initially slotting the end being the higher section 36 of the carriage 30 into the slot provided by the higher compartment 26 of the bracket 10 so that its lateral guides 39a and 39b provided upwardly at the higher section 36 can house lateral rollers being provided by the bearings 27 and 28 of the bracket 10. It is pushed in until the end roller 29 slots into the guide slot provided by the frontal guide cavity 38 of the carriage 30.

When the carriage 30 is fully housed by the first cavity 20 and the higher compartment 26 of the bracket 10, the roller provided by the guide wheel 34 on the carriage 30 is also housed in the bracket's 10 narrow slot provided by the second cavity 23, with consequent restriction of movement between the bracket 10 and the carriage 30, the movement of which coincides with the possible axial movement of the roller provided by the guide wheel 34 in its housing provided by the second cavity 23.

During connection of the bracket 10 to the carriage 30, the viscous fluid soft-closing system 37b is inserted in the compartment 37 of the carriage 30, to come into direct contact with the rack 37a and to be fitted, for instance with screws, to the bottom of the higher compartment 26 of the bracket 10, in a pre-established position.

The combined lateral guide action of the bracket's 10 bearings 27-28 on the carriage's 30 guides 39a and 39b alongside the transversal guide action of the bracket's 10 end bearing 29 in the guide provided by the frontal guide cavity 38, cause the bracket 10 to house the two parts, i.e. the flat member 31 and the higher section 36 of the carriage 30, essentially in their respective first cavity 20 and slot provided by the higher compartment 26, passing from the initial assembly position shown in FIG. 9 to the final operating position shown in FIG. 11.

The bracket 10 is therefore complete when the arm 14 is attached to its fitting slots 24-25, as illustrated in FIG. 11.

FIG. 11 also shows that following coupling, the carriage 30 and the bracket 10 are joined together by a twisted metallic pair of springs or elastic devices 80, which are placed under suitable tension to return the bracket 10 and its door 1 into the aligned position shown in FIG. 11, gradually working together with the soft-closing system 37b to gradually achieve this position.

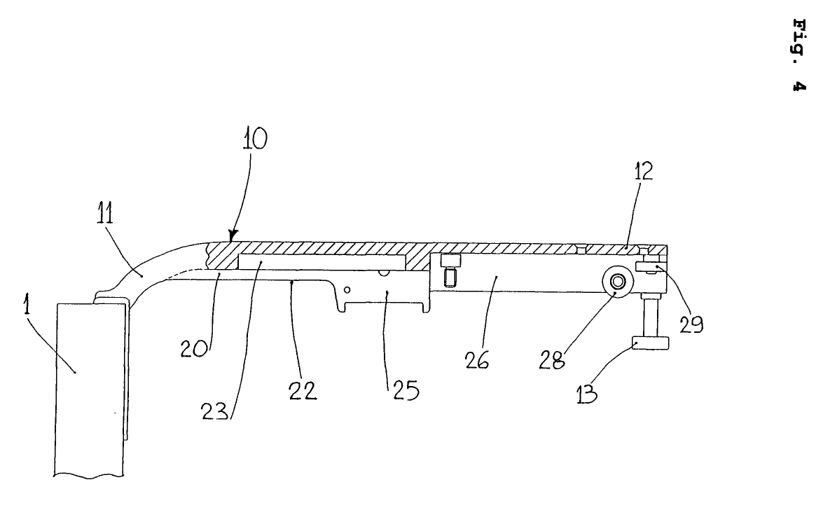

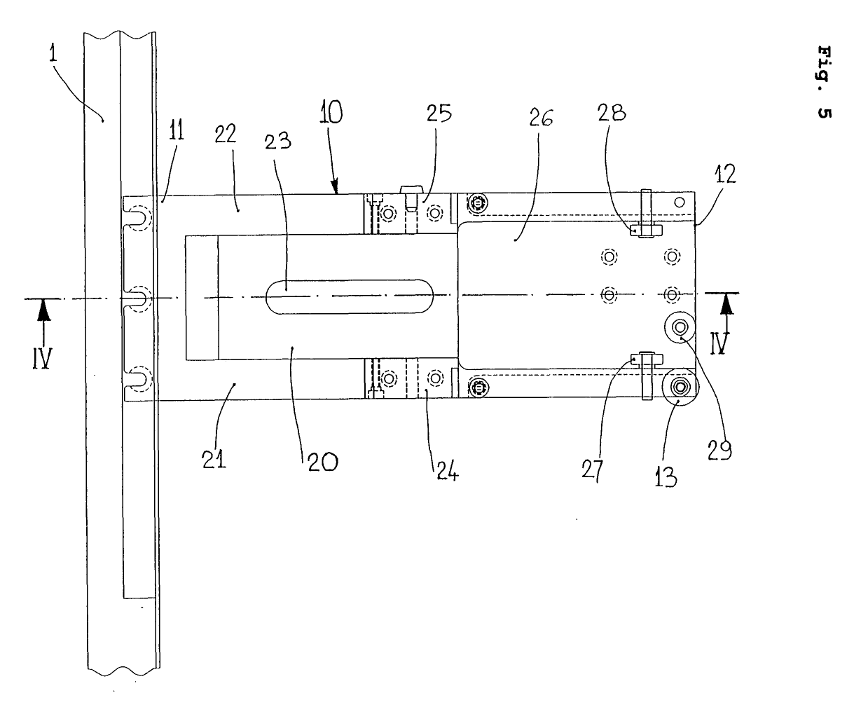

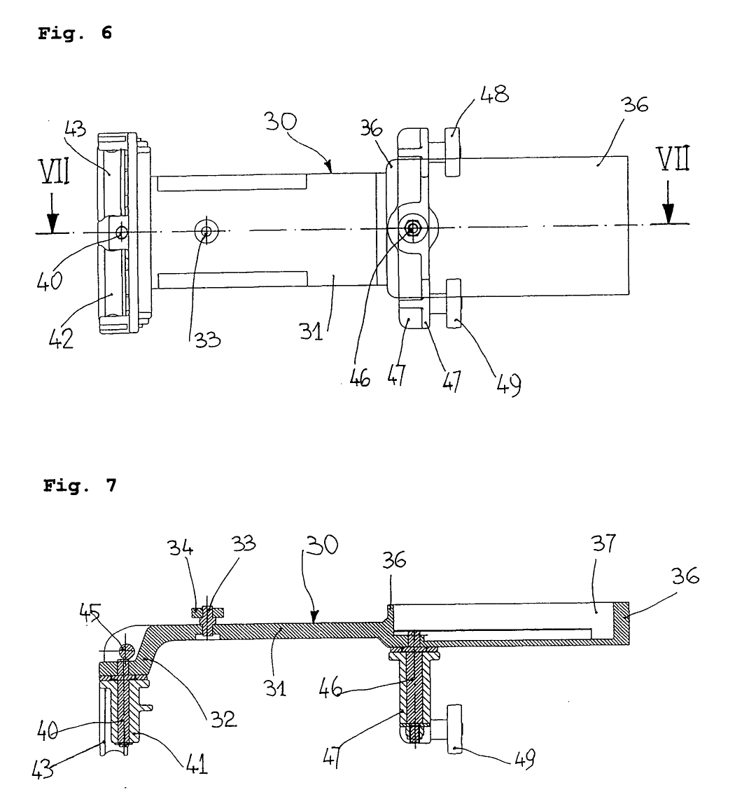

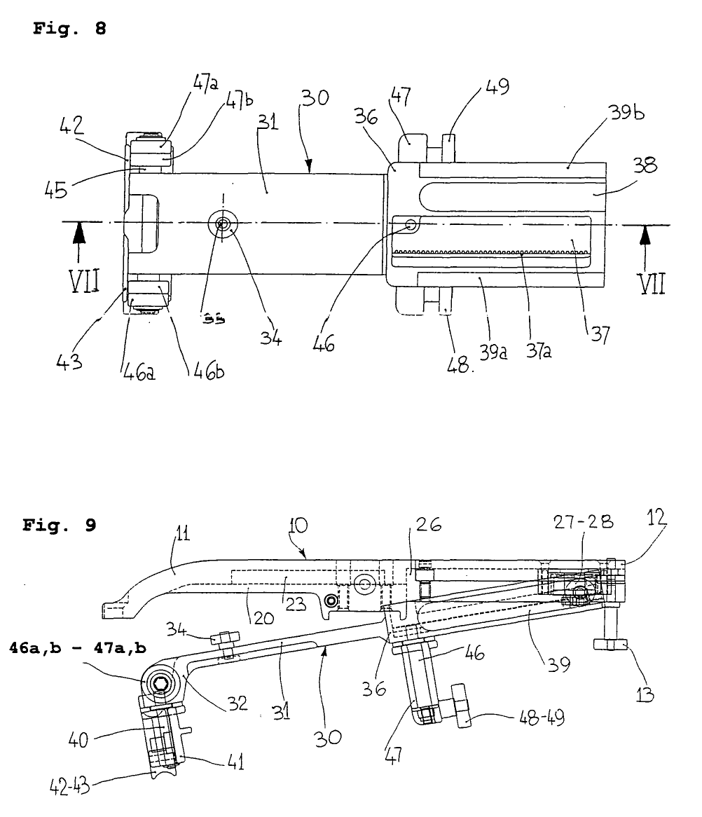

In particular reference to FIG. 3 and as previously mentioned, the plate or rail 50, is suitably fitted to the upper edge of the opening of upper panel C and has a track 51 and the balancing guide 52 formed as a balancing cavity, which extends along the entire length of the unit of furniture, while a suitable facing panel or head ribbing 53 both strengthens and consolidates the rail 50 in addition to obstructing the movement mechanisms from view, especially when the compartment V is open and the respective door 1 cannot cover this aesthetic function.

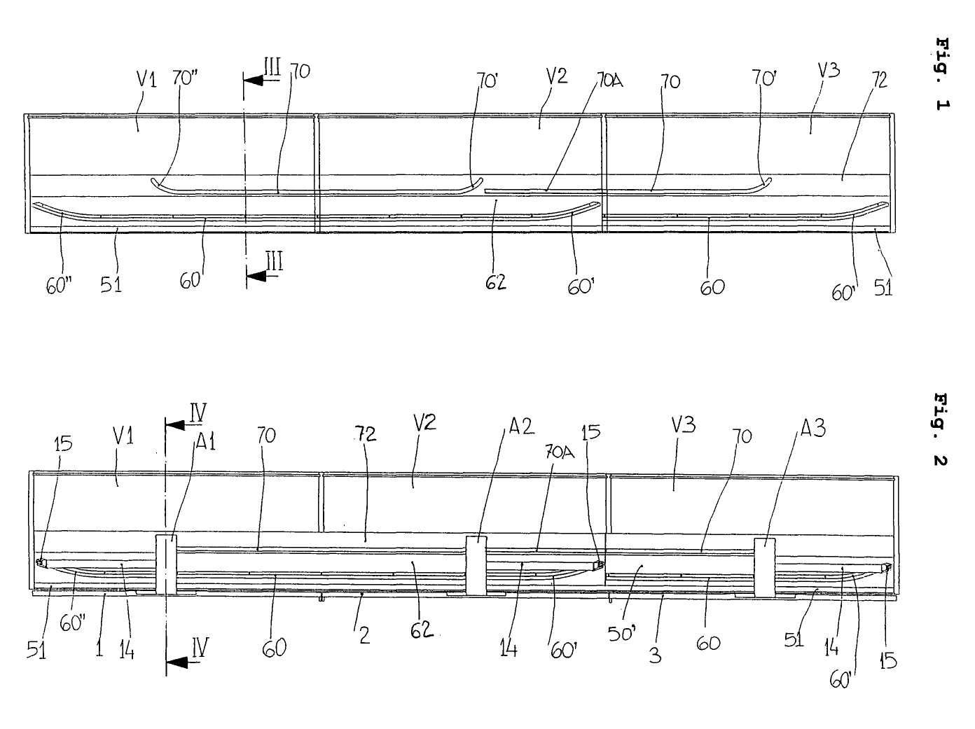

A longitudinal guide member 62 with undercut groove 60 that is essentially parallel to the track 51 is attached to the same plate 50, by means of rivets 61 for example. However, as illustrated in FIG. 1, at least one end has a wide curvature 60′ and, in the case of a single guide 60 for two adjoining compartments V1-V2, the same guide 60 also has a contrasting and corresponding large curvature 60″ at its other end.

Again in relation to FIG. 3, a vertical wall 55, that forms the aforementioned undercut compartment or balancing guide 52 parallel and distanced to the facing panel 53, also has a support structure 56 to support and attach, using screws 71 for example, a longitudinal guide member 72, from which the longitudinal guide member 72 a cavity or external cam guide 70 derives, which is essentially parallel to the track 51 and to the internal guide 60, with at least one end formed as a curvature 70′, that is shorter and more curved than the curvature 60′ at guide 60 and is thus farther away from the anterior edge of the upper panel C as also illustrated by FIG. 1.

More specifically, the curvatures 60′ and 60″ at the ends of the cam guide 60 are shorter than the curvatures 70′-70″ at the ends of the cam guide 70 by a value that corresponds to the length of the arm 14 or rather to the longitudinal distance between axles of the wheels or bearings 13 of the first sensing device and the wheels or bearings 15 of the second sensing device.

In the random construction solution illustrated in FIGS. 1-2 and 17-18, a third compartment V3 is shown next to two compartments V1-V2, the doors 1 and 2 of which are activated by identical and opposing devices A1 and A2, together with a single rail 50 with a track 51 and a balancing guide 52 as well as with the cam guides 60 and 70. This third compartment V3, that can be closed by one of its doors 3 which is equipped with a third device A3 that is identical to the device A2 and therefore also has a dedicated section of rail 50′ and with two dedicated sections of the cam guides 60 and 70 and their curvatures 60′, 70′. The opening of said door 3 also partly utilises said rail 50, which is also used to move the central door 2.

In the presence of a third compartment V3, to ensure the opening of the door 3 in front of the compartment V3 during overlapping of the adjoining door 2, the section of guide member especially formed as the cam guide 70 attached to the upper panel of the compartment V3 must be aligned to a linear section 70A positioned on the upper section of the compartment V2. As is also shown in FIG. 1, this linear section 70A can consist of a single plate formed as the longitudinal guide member 72 including the guide 70 and the curved ends being the curvatures 70′ and 70″ respectively overlapping the compartments V2 and V3.

A brief summary of functionality will now follow, based on the constructive solution until now described and illustrated. This will also serve to check consistency with the achievement of the specified objects.

One type of device A is available for fitting to the door 1 in the form of device A1, to the door 2 in the form of device A2, and to the door 3 in the form of device A3, for their aligned closure and overlapping opening, of a three-compartment V1, V2, and V3 unit of furniture for example. The compartments V1-V3 can utilise a single rail 50 with a single track 51 and a single balancing guide 52 formed as slot along the entire length of the unit of furniture.

Two of these identical first and second devices A1, A2 have their arms 14 in a contrasting position and have a single pair of cam guides 60 and 70, both with curved ends formed by the curvatures 60′-60″ and 70′-70″.

The arm 14 of the third identical device A3, is in the same position as the second device A2 and has a pair of cam guides 60-70 each with only one curved end formed by curvature 60′-70′, and a total length that is essentially halved and corresponds to the length of compartment V3, which it must open and close.

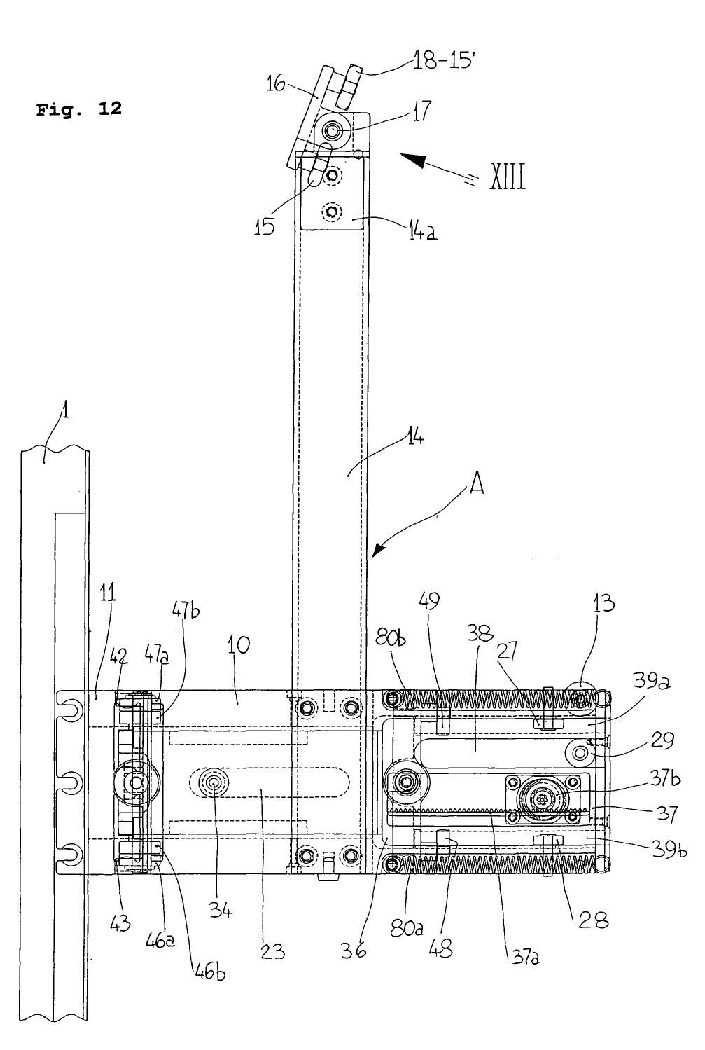

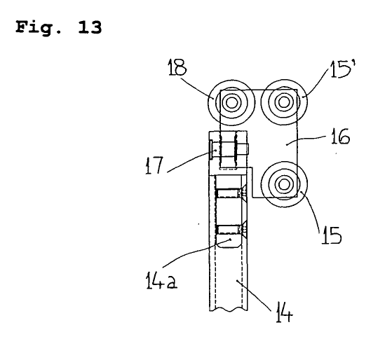

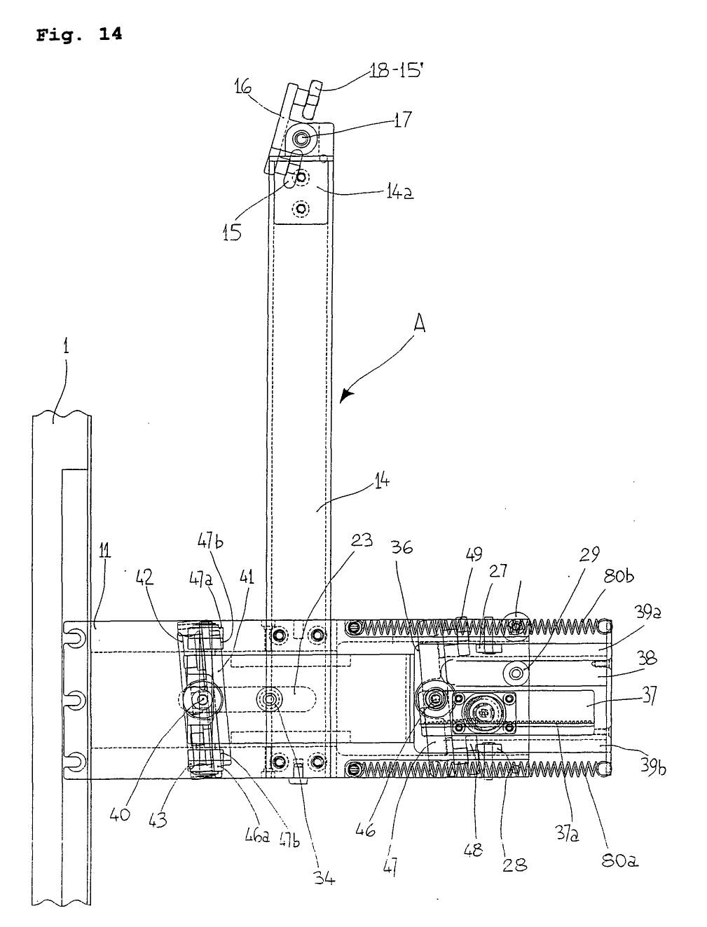

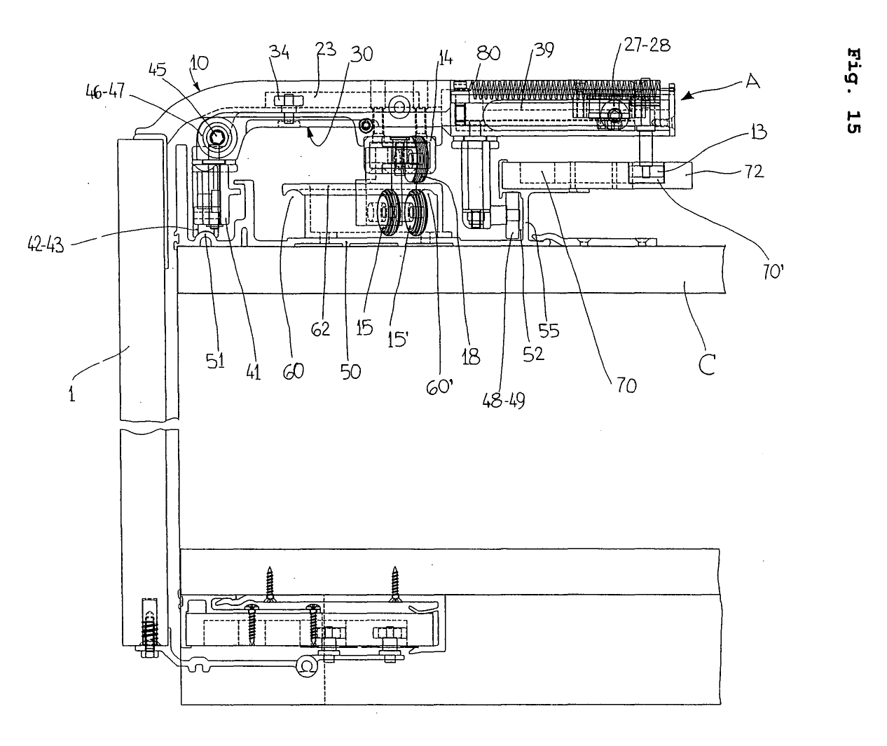

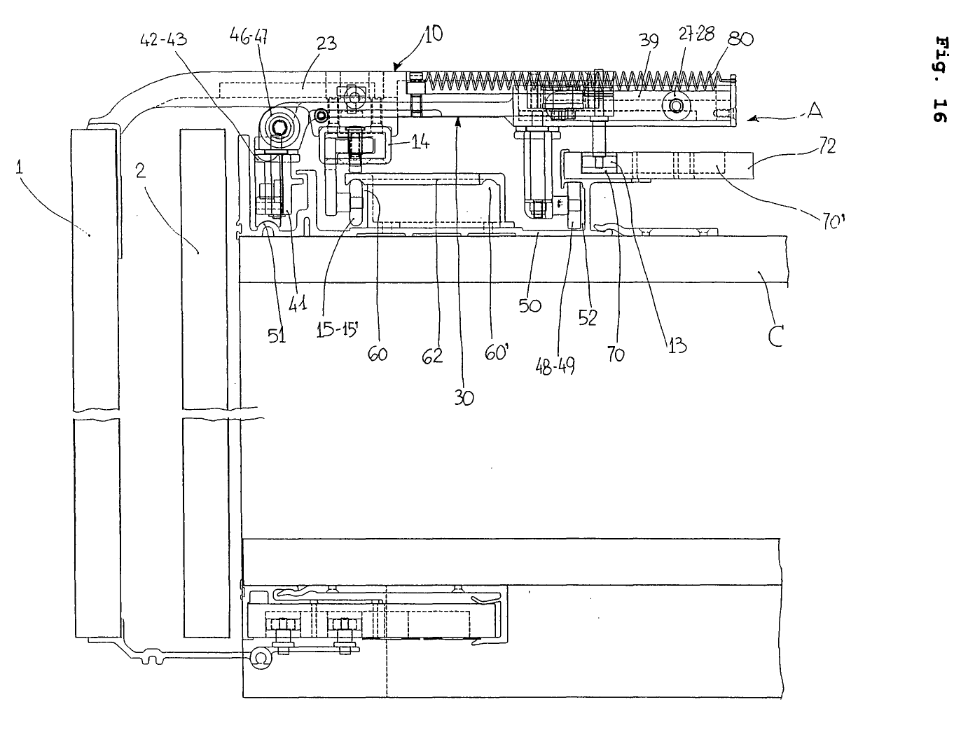

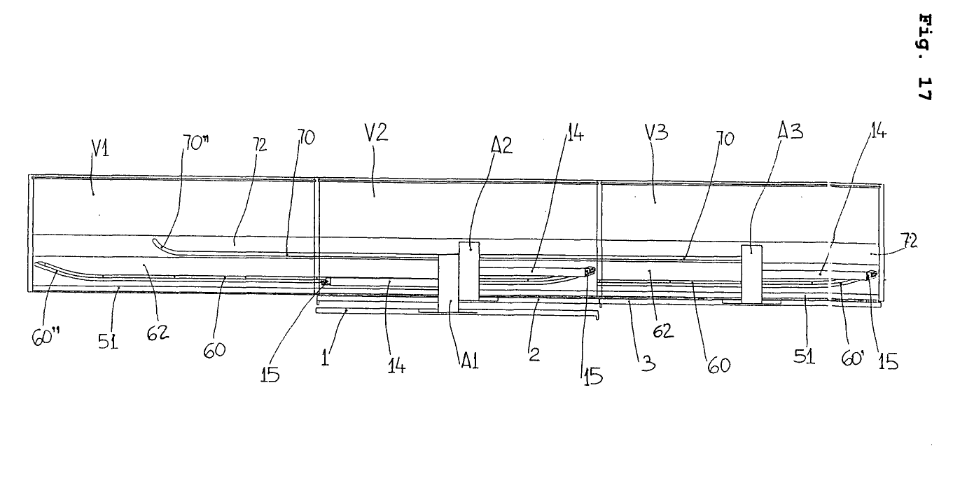

After assembling each device A1-A2-A3, by connecting the bracket 10 to its underlying carriage 30 and upon fitting the respective arm 14 as shown in FIGS. 11 and 12, the next step is to place each device A1-A3 in sequential order along the rail 50 by placing the rollers 48-49 in the balancing guide 52 and by positioning the pulleys 42-43 on the track 51.

At the same time, moving the carriage 30 transversally along the tracks 21-22 of each bracket 10, forces the sensing wheel 13 to slot into its dedicated cam guide 70 and consequently moves and slots the sensing wheels or bearings 15-15′ of the arm 14 into the cam guide 60 of the respective member 62.

When the sensing wheels or bearings 15-15′ slot into the cam guide 60, the external guide wheel 18 is also placed on the external surface of the guide member 62 thus preventing the sensing wheels or bearings 15-15′ from accidentally slipping out of their cam guide 60, even in the event of knocks or unexpected pressure, especially because the opening comprising the cam guide 60 is open merely in frontal direction.

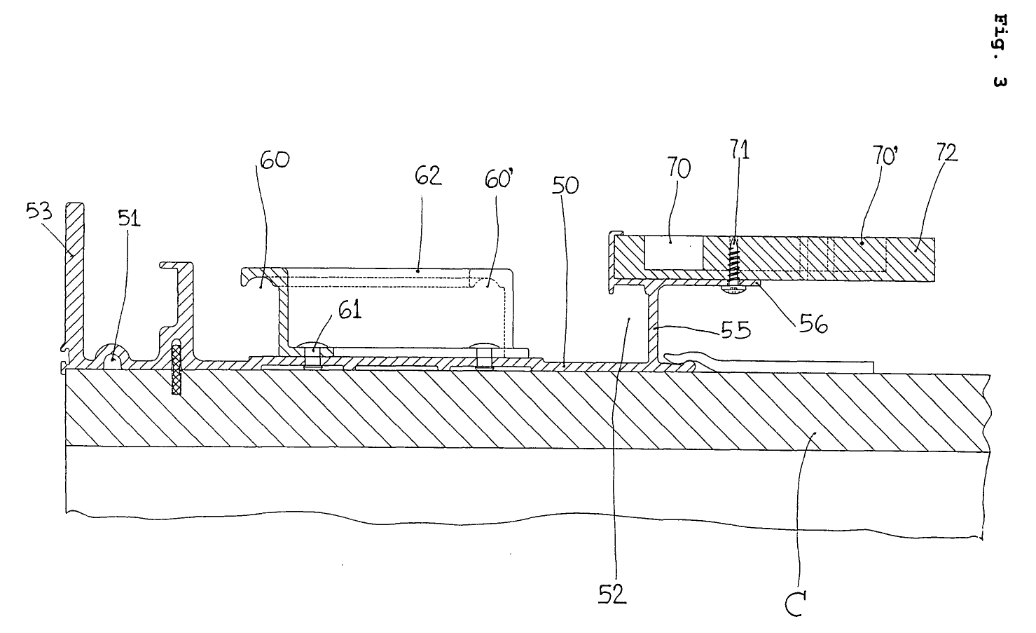

After the three devices A1-A2 and A3 are thus aligned in sequential order, the respective doors 1-2 and 3 can now be fitted, with the ends 11 of the respective brackets 10 fitted at approximately the centre-line of the upper side of the corresponding bracket of the doors 1, 2, and 3, as illustrated in FIG. 2.

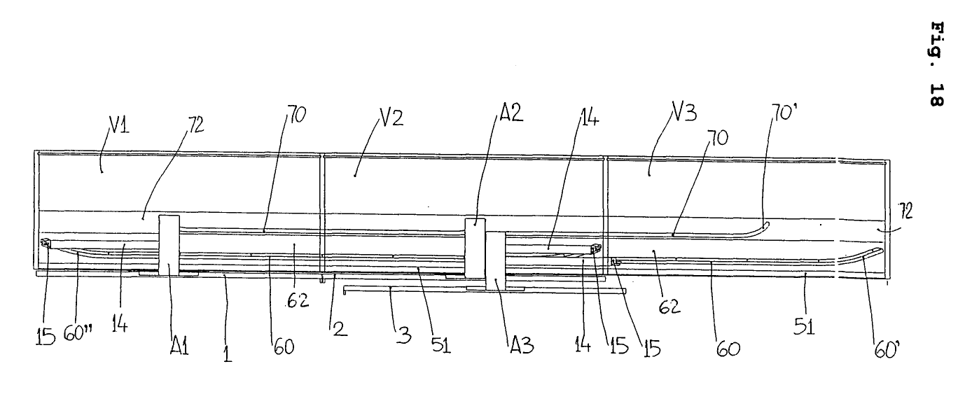

In relation to FIGS. 17 and 18, the next step is to close compartment V1 by moving to the left the first door 1, which is open and overlapping the second door 2, with the first door's device A1 with sensing wheel being a bearing 13 and sensing wheel being a bearing 15-15′ positioned on the straight section of the respective pair of cam guides 60 and 70.

The carriage 30 of this first device A1 moves, dragged by the operating element on the door 1 without any transversal movement of the carriage 30 and the bracket 10 that it supports, and transports to the left until the pair of second sensing wheels of the bearing 15 of the arm 14 meets the curved section formed by the curvature 60″ of the cam guide 60 along which it runs.

Introducing the use of the second sensing wheels of the bearing 15 in this curved section formed by the curvature 60″, while the sensing wheel of the bearing 13 at opposite end of bracket 10 is still in use on the straight section of the cam guide 70, the bracket 10 is forced to incline due to its rigid connection to the arm 14 supporting the sensing wheel 15.

As the bracket 10 inclines, so does its door 1, while the pulleys 42-43 and the wheels of the bearings 48-49 of the carriage 30 are forced to follow a straight path that is defined by the track 51 and by the balancing guide 52. The carriage 30 is forced to follow the inclination of the bracket 10, to which it is fitted via first cavity 20 and compartment 26 and by the driving bearings 27, 28 and 29.

Consequently, the plate 41, rotating on its pivot 40 formed as a pin at frontal end of carriage 30, allows orientation of the pulleys 42-43, which can remain on the track 51, while the carriage 30 inclines with the bracket 10, for the overlapping phase of the door 1 with the other door 2.

Continuing the traction on the closing door 1, the sensing device of it also comes into contact with the start of the curvature 70″ of its cam guide 70.

In the same way as for the plate 41 at frontal end of carriage 30, the plate 47 at vertical bar downwardly extending from wider and higher section 36 also rotates on its pin or vertical bar 46 to allow its guides formed by the wheels 48-49 to run along the linear guide 52 despite the fact that the bracket 10 is still inclined, by effect of the position of the sensing device formed by the wheels or bearings 15 in the curved section 60″ of the cam guide 60.

With the arrival of the sensing device formed by the bearings 13 arranged at the opposite end 11 of the bracket 10, in the curved section 70″ of the cam guide, the bracket 10 rapidly realigns with its carriage 30 with consequent final alignment of the door 1 with the adjoining door 2 upon full closure of the compartment V1.

It is clear that the difference in lengths and the different curvature radius of the end forming the curvatures 60″ and 70″ of the cam guides 60 and 70 where the sensing devices wheels or bearings 13 and 15 of the bracket 10 run, as well as the different positioning of the start and end points of the curvatures 60″ and 70″, also determine the different axial position of the bracket 10 compared to the underlying support carriage 30 that is linearly connected to the track 51, thus allowing both the desired inclination and the required movement of the door 1 on the adjoining closed door 2 for each opening and for each closure of the compartment V1, thus fulfilling one of the objectives of the innovation.

In particular, the movement of the door 1 is determined by the movement of the bracket 10 on the carriage 30. This movement is made possible by the sliding mechanism of the running or sliding tracks 21-22 on the wheels 46-47 of the carriage 30 and by means of the driving bearings 27-28 on lateral grooves 39 of said carriage 30 by effect of the position of the sensing devices comprising the wheels or bearings 13 and 15 on the cam guides 70 and 60 upon each pushing action arising from the opening or closing of the door 1.

The movement of the bracket 10 and its door 1 on the carriage 30 is determined by their capacity for inclination during overlapping of the adjoining door 2 and on the structure of the cam guides 60 and 70 as well as on the position of the sensing devices, which they house.

Especially, the devices A1-A3 are positioned such that one of the devices like first device A1 acts together with the curvatures 60″ and 70″ on first end of the cam guides 60 and 70, and that the other of the devices like second device A2 acts together with the curvatures 60′ and 70′ on the other, second end of the cam guides 60 and 70 arranged above the second compartment V2. The third one of the devices like third device A3 acts together with the curvatures 60′ and 70′ on the other, second end of the third compartments V3 cam guides 60 and 70. The curvatures 60′ and 70′ arranged above the second compartment V2 are curved in same direction like the curvatures 60′ and 70′ arranged above the third compartment V3.

The presence of a well-known type of viscous fluid soft-closing system 37b, with its rack 37a in the compartment 37 of the carriage 30, allows for gradual movement of the bracket 10 on the carriage 30 against the reaction of springs or elastic devices 80, which automatically tend to bring the bracket 10 and its door 1 back into alignment with the other doors 2 and 3. The springs or elastic devices 80 can be tensed e.g. between the opposite end 11 of the bracket 10 and a middle section of the carriage 30.

Naturally, the illustration relative to compartment V1 closure also applies to subsequent opening of the same compartment V1, inverting the pushing action on the door 1 and inverting the inclination and overlapping phases of the same door on the adjoining door 2.

Similarly, the compartment V2 can be opened by the door 2, with an initial inclination that is determined by the position of the sensing devices formed by its wheels or bearings 15 and 13 in relation to the corresponding curved sections 60′ and 70′ of the cam guides 60-70 and with subsequent movement, due to sliding of the bracket 10 of it on its carriage 30.

One of the main benefits of the innovation is highlighted in FIG. 18. This consists in the fact that a third device A3 in question, identical to device A2, can also be used to open an unevenly numbered third compartment V3, adjoining two, first and second compartments V1-V2 and connected to them via two sections of further cam guides 60-70, which are identical to cam guides 60-70 of the adjoining first and second compartment member, and via a section of linear guide 70A to be attached to the upper panel of the adjoining second compartment V2 to give continuity to the movement of the sensing device formed by its wheels or bearings 15, when it leaves the upper panel of the compartment V3.

The narrow width of the bracket 10 of the second device A2 allows the bracket 10 of the third device A3 to transport the third door 3 to the almost fully open position of the third compartment A3 while ensuring alignment with the same third door 3 when closed, and utilising a single rail 50, in keeping with some of the specified objects.

The presence of the arm 14, allows the device in question to be positioned at approximately the centre-line of the various doors 1-3, together with the transversal balancing function of the wheels 48-49 in the guide 52 even in relation to longitudinal balancing thus ensuring the greater dimension and weight of the doors to be attached as well as maximum ease of movement, in line with another of the specified objectives.

As has already been outlined, the assembly solution herein illustrated and described, may of course be altered to take on other forms of assembly.

For example, the wheels 13 and 15 of the sensing device or the sliding wheels 46-47 of the bracket 10 on the carriage 30 and the wheels 48-49 of the balancing guides 52 and the wheels of the pulleys 42-43 can be replaced with sliding blocks or with bronze or Teflon pegs. Furthermore, for example the number of wheels, pulleys and bearings to be fitted to the various sections of longitudinal and transversal movement of the bracket 10 and its carriage 30 can be changed. Further, there can be arranged furniture having more than three compartments and sliding doors.

1. Mechanism for the aligned closure of sliding doors (1-3), in particular for furniture or compartments (V1-V3) with two or more doors (1-3), with a sliding door (1, 2 or 3) for each compartment (V1-V3), and where each compartment (V1-V3) opens by sliding and overlapping of one of the doors (1, 2, 3) with one of the adjacent doors and closes in alignment with at least one of the adjacent door, characterised in that it comprises
a single bracket (10) or support plate for each of the doors (1, 2, 3), one end (11) of the bracket (10) being positioned on the upper side of said door (1, 2, 3), especially being positioned approximately on a centre line of the upper side of said door (1, 2, 3), the opposite end (12) of the bracket (10) being equipped with a first sensing wheel or bearing (13), to be positioned at or in and to run along a longitudinal cam guide (70; 70, 70′, 70″), said bracket (10) being suitable for inclination and transversal movement with a longitudinal sliding carriage (30), which also allows the bracket (10) via the carriage (30) to slide along a rail (50) preferably to be positioned on the edge of the upper surface of the compartments (V1-V3) to be closed or opened;
the longitudinal sliding carriage (30) of the bracket (10) and of its door, said carriage (30) being equipped with one or more bearing elements or pulleys (42, 43) that are adjustably transversally and by one or more bearing elements or wheels (48, 49) that are rendered transversally adjustable and by its sliding movement along the rail (50), in addition to being equipped with pivot wheels or bearings (27-29, 34, 46a,46b,47a,47b) on which the bracket (10) can move axially in relation to the carriage (30) and can therefore move transversally in relation to the longitudinal opening and closing movement of the doors (1, 2, 3) to open or close the compartments (V1-V3); and
an arm (14), one end of which is firmly attached to the support bracket (10) of each door (1, 2, 3), while the other end (14a) is equipped with at least a second sensing device having at least one wheel (18) or bearing (15, 15′), to be positioned and to run along an other longitudinal cam guide (60, 60′, 60″) using the same bracket (10) for inclination and movement, with its door (1, 2, 3) in motion, in relation also to the form of the cam guide (60, 60′, 60″) to which the second sensing device is connected.

2. Mechanism as per claim 1, characterised in that, the one end (11) of the bracket (10) can be firmly attached to the centre line of the upper edge of a door (1), while the other end (12) of the bracket (10) is equipped with at least a first sensing device having the first sensing wheel or bearing (13), to be positioned and to run along the longitudinal cam guide (70) that has curved structure of its ends formed as curvature (70′, 70″), and while the bracket (10) together with the first sensing device and with a second sensing device having such second sensing wheel or bearing (15), attached to a second cam guide (60) having curved ends formed as curvatures (60′, 60″), defines the inclination and the movement by which the door (1), during opening of the compartment (V1), can overlap the adjoining door (2) that is closed over its adjoining compartment (V2).

3. Mechanism as per claim 2, characterised in that a bracket (10) of any other door (2, 3) has one end (11), which can be firmly attached at the centre line of the upper edge of the corresponding same other door (2, 3), while the other end (12) is equipped with at least a first sensing device having such first wheels or bearings (13), to be positioned and to run along the or such a cam guide (70) that has curved structure of its ends formed as such curvatures (70′, 70″), and that this bracket (10) together with a second sensing device having such second wheels or bearings (15), attached to the or such a second cam guide (60) and its curved ends formed as curvatures (60′, 60″) defines the inclination and the movement by which the same other door (2, 3), during opening of the corresponding compartment (V2, V3), can overlap the adjoining door (1 or 2) that is closed over its adjoining compartment (V1, or V2).

4. Mechanism as per claim 2 or 3, characterised in that each bracket (10) is rendered stable by one end of arm (14), while the other end (14a) is equipped with the second sensing device, preferably arranged with two wheels or bearings (15, 15′) and with a stabilising bearing or wheel (18) attached to an adjustable plate (16), said wheels or bearings (15, 15′) sliding within a cam guide (60), which with it curvatures (60′, 60″) and together with the movement of the first sensing device (13) are capable of setting the inclination required in the bracket (10) for closing the respective door (1, 2, 3) by overlapping of the adjoining door (2, 1, 2) during the opening phase of its compartment (V1, V2, V3) as well as setting the closure alignment position.

5. Mechanism as per any of claims 2 to 5, characterised in that each bracket (10) has a lower surface that has a compartment or first cavity (20), on the one end (11) and a compartment (26) on the opposite end (12), said compartments being suitable for housing and guiding an upper section of two respective joint members (31) or sections (36) of the co-operating carriage (30), this carriage (30) being guided within said compartments or cavities (20, 26) by the wheels or bearings (27, 28, 29) and by its bearings or wheels (46, 47), which slide along tracks (21, 22) of the same bracket (10).

6. Mechanism as per any of claims 1 to 5, characterised in that the carriage (30) has one end (32) with an attached pivot (40), especially pin or bar, which allows a plate (41) to move on said pivot (40), thus also allowing movement of the idler bearing elements or pulleys (42, 43) that are adjustably transversally and being positioned on the plate (41).

7. Mechanism as per any of claims 1 to 5, characterised in that the carriage (30) has a section (36), that contrasts section (31) and is deeper, wider and/or higher enabling it to house lateral guides (39) and a frontal guide, especially fronatl guide cavity (38), in addition to having a compartment (37) to house a viscous-fluid soft-closing system (37b) to act on one of its racks (37a) that is housed in the same compartment (37) and has a dampening action in respect of the traction action of elastic devices (80) arranged to return the bracket (10) into alignment on the carriage (30).

8. Mechanism as per claim 6 or as per claims 6 and 7, characterised in that, in a suitable axial position, a pin or bar (46) is solidly attached to the higher section (36) of the carriage (30), said pin or bar (46) being capable of moving a further plate (47) to which the especially two bearing elements or wheels (48, 49) that are rendered transversally adjustable at the carriage (30) are attached, these wheels being able to be positioned in a transversal balancing guide (52) of the rail (50).

9. Mechanism as per any of the previous claims, characterised in that the rail (50) being a single rail (50), inclusive of a track (51), on which are positioned a pair of the adjustable sliding bearings or pulleys (42, 43) of the carriage (30), and inclusive of a balancing guide (52), on which are positioned a pair of the adjustable sliding wheels (48, 49) of the carriage (30), said rail (50) being attached to the upper surface of a top panel (C) of the unit of furniture or at any element covering two or more compartments (V1, V2, V3), and said rail (50) being positioned alongside two guide members (62, 72), of the cam guides (60, 70) for a pair of compartments (V1, V2), as well as to sections of said guide members (62, 72) with cam guides (60, 70) for each adjoining compartment (V3).

10. Mechanism as per claim 9, characterised in that such a guide member (62) presents an undercut undercut groove (60) that is parallel to and in proximity to the track (51), with at least one end curvature (60′, 60″) having an especially large curve ending with the compartment to be opened in proximity of an external side of the compartment or unit of furniture.

11. Mechanism as per claim 9 or 10, characterised in that such a guide member (72) with an upper groove (70) running parallel to the track (51) but is positioned to the rear of the guide (60), and having at least one end curvature (70′, 70″) with a narrower curvature radius than that of the other guide (60), being even inferior to the value corresponding to the length of the arm (14) of the bracket (10) attached to it.

12. Mechanism as per any of claims 1 to 11, characterised in that the alignment of the first sensing device having the first wheels or bearings (13) of the bracket (10) in the cam guide (70) of a/the guide member (72), allows the bracket (10) and its door (1) to move however much is necessary to reach the closed aligned position, with the sensing device (13) positioned along the final curved section formed by a/the curvature (70′, 70″) of that cam guide (70) in an open position, overlapping the adjoining door (2), with the sensing device having the first wheels or bearings (13) positioned along a straight section of that cam guide (70).

13. Mechanism as per any of claims 1 to 12, characterised in that the alignment of the second sensing device having the second wheels or bearings (15) of the cam guide (60) of a/the member (62) allows the bracket (10) to move and incline via its arm (14) by however much is necessary, together with its door (1) to reach a closed aligned position, with the sensing device having the second wheel's or bearings (15) positioned along its final curved section formed by a/the curvature (60′, 60″) of that cam guide (60) to an open position, overlapping the adjoining door (2), with the sensing device having the second wheels or bearings (15) positioned along a straight section of that cam guide (60).

14. Mechanism as per any of claims 1 to 13, characterised in that the sliding, inclination and movement of each bracket (10) and its door (1, 2, 3), in relation to the bracket (10) and the adjoining door (2, 1, 2), is made possible and concurrent, by the presence of some/the adjustable plates (41, 47) on the carriage (30), through which the bearings or pulleys (42, 43) and wheels (48, 49) can remain aligned to the rail (50) and or a/the track (51) thereof and to a/the transversal balancing guide (52), while the carriage (30) inclines with the bracket (10) to which it is attached at a/the first compartment or cavity (20) and a/the compartment (26) formed in the bracket (10).

15. Mechanism as per any of claims 1 to 14, characterised in that the opposite end (14a) of the arm (14) being extended in a direction parallel to the rail (50) and being distanced from the bracket (10) in the direction parallel to the rail (50).

16. Mechanism as per any of claims 1 to 15, characterised in that each of devices (A1-A3) each comprising one of the brackets (10) and its carriage (30) are positioned such that one of the devices (A1) acts together with curvatures (60″, 70″) on a first end of one of the cam guides (60, 70) arranged above the first compartment (V1), and that the other of the devices (A2) acts together with curvatures (60′, 70′) on the other, second end of the cam guides (60, 70) arranged above the second compartment (V2).

17. Mechanism as per claim 16, characterized in that the third one of the devices (A3) acts together with the curvatures (60′, 70′) on the other, second end of such cam guides (60, 70) above the third compartment (V3), in which the curvatures (60′, 70′) arranged above the second compartment (V2) are curved in same direction like the curvatures (60′, 70′) arranged above the third compartment (V3).
